(19) United States
(12) Patent Application Publication
(10) Pub. No.: US 2006/0294082 A1
(43) Pub. Date: Dec. 28, 2006

(54) Apparatus and method for playing content according to numeral key input

(75) Inventors: In-sik Myung, Incheon Metropolitan City (KR); Hyun-joo Kang, Seoul (KR); Sang-hwan Kim, Seoul (KR); Hyun-mi Park, Suwon-si (KR); Seung-eok Choi, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD

(21) Appl. No.: 11/476,102

(22) Filed: Jun. 28, 2006

(30) Foreign Application Priority Data
Jun. 28, 2005 (KR) 10-2005-0056440

(51) Int. Cl. G06F 17/30; G09G 5/00

(52) U.S. Cl. 707/3; 345/156

(57) ABSTRACT

An apparatus and method is provided for playing content according to a numeral key input. The method converts a combination of numerals input using numeral keys of a remote controller into temporal information such as a date or a time, and retrieves and plays frames of a still image or moving image corresponding to the temporal information. The apparatus for playing content according to a numeral key input includes a receiver for receiving a combination of numerals, a converter for converting the received combination of numerals into temporal information, a retriever for retrieving content corresponding to the temporal information with reference to the converted temporal information, and a player for playing the retrieved content.

### CROSS-REFERENCE TO RELATED APPLICATION

This application claims priority from Korean Patent Application No. 10-2005-0056440 filed on Jun. 28, 2005, in the Korean Intellectual Property Office, the disclosure of which is incorporated herein by reference in its entirety.

### BACKGROUND OF THE INVENTION

1. Field of the Invention

Apparatuses and methods consistent with the present invention relate to playing content according to a numeral key input, and more particularly, to playing content according to a numeral key input that converts a combination of numerals input using numeral keys of a remote controller into temporal information such as date or time, and retrieves and plays frames of a still image or moving image corresponding to the temporal information.

2. Description of the Prior Art

As the Internet, which was limited in the past, spreads widely through web implementations, the entire digital industry is greatly affected. Internet-based services and content have become essential parts of the 21^{St} century digital industry. In addition, with the start of content circulation using high-speed Internet, portable phones, personal data assistants (PDAs), notebook computers, and others multimedia distribution has become a necessity.

In this respect, a transition from the analog television (TV) to the digital TV is in progress. Viewers have come to receive various kinds of information through the TV.

FIG. 1 shows the advance of digital technology.

In the 1980s, information was exchanged through a network composed of personal computers (PCs), notebook computers, main frame computers, and workstations. This network was used in limited areas such as research institutes and offices.

In the 1990s, the Internet grew gradually, and interest in home stations gradually rose, and the Internet, which had been used in limited areas such as research institutes and offices, spread to individuals and homes.

Currently, wireless networks are being developed and the transmission speed of wire networks is increasing rapidly. As a result, circulation of large-capacity multimedia content has become significant and research into digital broadcasting is being actively conducted. Some services have already been commercialized. Meanwhile, much information technology has been changed into ubiquitous information technology (IT). Digital information is now transmitted and received not only through computers or workstations, but also through digital TVs, portable phones, video phones, smart phones, and others. Additionally, digital information can be transmitted and received among ubiquitous electronic appliances such as refrigerators, microwave ovens, and air conditioners of a home network.

Each user utilizes a device, such as a remote controller, a home console or a wall console, to retrieve various kinds of digital information. However, it is difficult to retrieve such digital information due to the characteristics of these devices.

That is, if digital information that the user desires to retrieve is stored in the a file, the user utilizes an arrow button on the remote controller to retrieve a small number of files (for example, 10 to 20 files). However, with an increase in the number of files (for example, hundreds to thousands of files), it is not easy to retrieve desired information using only the arrow button.

In other words, the retrieval of information through the arrow button is not suitable for retrieval of large amounts of digital information. In this respect, a device for easily retrieving digital information using a specified address that stores respective digital information is required.

FIG. 2 is a conceptual view illustrating the playing of retrieved information using a conventional playback apparatus.

As illustrated in FIG. 2, the conventional playback apparatus 22 plays information 21 selected by a user. At this time, the user utilizes an arrow button of a remote controller 23 to retrieve stored information 21. Generally, the information 21 is stored one-dimensionally depending on predetermined conditions. In other words, the information 21 is stored in good order depending on conditions such as file name, file size, file type, generation date, or date of update. Therefore, the user can only access information sequentially by clicking the arrow button repeatedly. To this end, the user needs to click the arrow button several times to retrieve information far away from the current position.

Korean Patent Unexamined Publication No. P2002-0096002 discloses a method for retrieving a program guide screen, in which program information corresponding to a time period input by a user is displayed. In this conventional method, if the user inputs a numeral, it is determined whether an input mode corresponds to a time input mode or a channel input mode. Thus, if it is determined that the input mode corresponds to the channel input mode, a channel corresponding to the numeral input by the user is displayed. On the other hand, if it is determined that the input mode corresponds to the time input mode, program information corresponding to the time input by the user is displayed after it is determined that the time input by the user is valid.

However, since the program information corresponding to the input time is retrieved, only specified information among a limited amount of information is retrieved. Therefore, an apparatus or method for retrieving specific information among mass information is still required.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

The present invention provides an apparatus and method for playing content according to a numeral key input, which converts a combination of numerals input using numeral keys of a remote controller into temporal information such as date or time, retrieves and plays frames of a still image or moving image corresponding to the temporal information.

According to an aspect of the present invention, there is provided an apparatus for playing content according to a numeral key input, according to the present invention, which includes a receiver for receiving a combination of numerals, a converter for converting the received combination of numerals into temporal information, a retriever for retrieving content corresponding to the temporal information with reference to the converted temporal information, and a player for playing the retrieved content.

According to another aspect of the present invention, there is provided a method for playing content according to a numeral key input, which includes receiving a combination of numerals, converting the received combination of numerals into temporal information, retrieving content corresponding to the temporal information with reference to the converted temporal information, and playing the retrieved content.

### BRIEF DESCRIPTION OF THE DRAWINGS

The above and other aspects of the present invention will become more apparent from the following detailed description of exemplary embodiments taken in conjunction with the accompanying drawings, in which:

FIG. 1 is a view explaining the progression of digital technology;

FIG. 2 is a conceptual view illustrating the playing of retrieved information using a conventional player;

FIG. 3 is a block diagram illustrating the construction of an apparatus for playing content according to a numeral key input according to an exemplary embodiment of the present invention;

FIG. 4 is a view illustrating the retrieving and playing of still images according to an exemplary embodiment of the present invention;

FIG. 5 is a view illustrating a display manner of a position bar according to an exemplary embodiment of the present invention;

FIG. 6 is a view illustrating the playing of moving images according to an exemplary embodiment of the present invention; and

FIG. 7 is a flowchart illustrating a method for playing content according to a numeral key input according to an exemplary embodiment of the present invention.

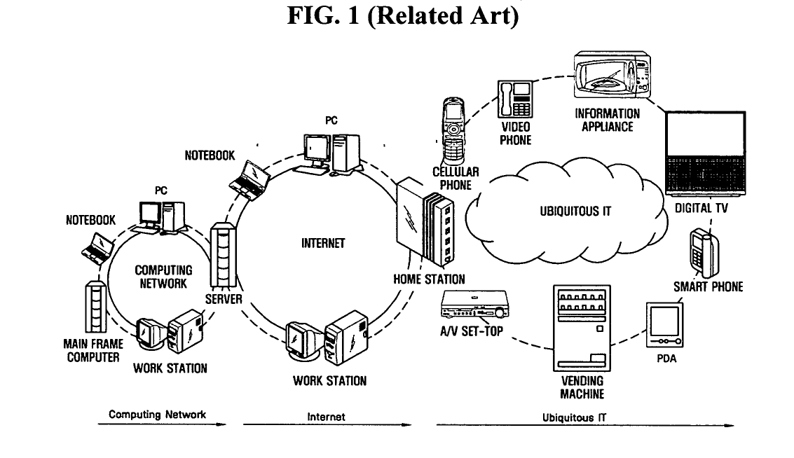

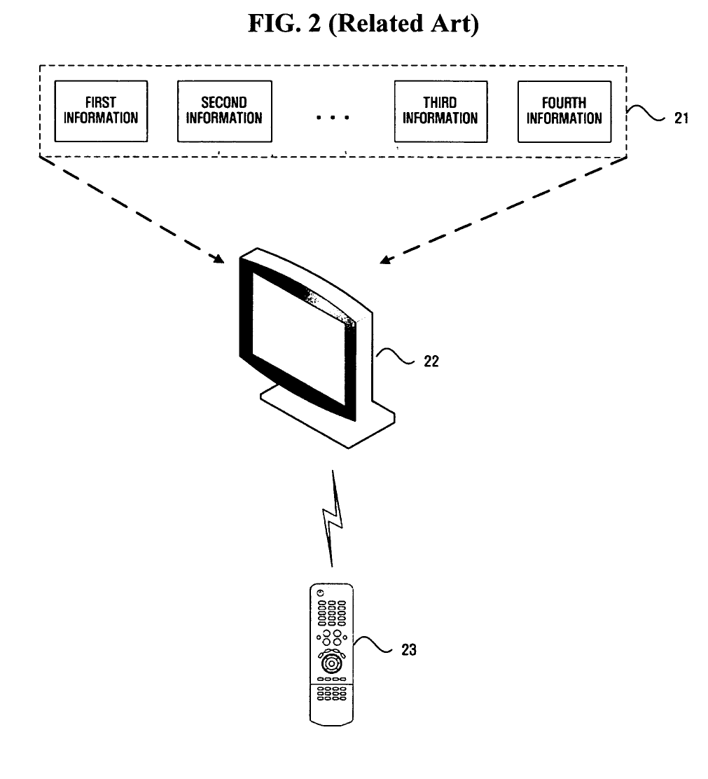

### DETAILED DESCRIPTION OF THE EXEMPLARY EMBODIMENTS

Hereinafter, exemplary embodiments of the present invention will be described in detail with reference to the accompanying drawings. The aspects and features of the present invention and methods for achieving the aspects and features will be apparent by referring to the exemplary embodiments to be described in detail with reference to the accompanying drawings. However, the present invention is not limited to the exemplary embodiments disclosed hereinafter, but can implemented in diverse forms. The matters defined in the description, such as the detailed construction and elements, are nothing but specific details provided to assist those of ordinary skill in the art in a comprehensive understanding of the invention, and the present invention is only defined within the scope of appended claims. In the whole description of the present invention, the same drawing reference numerals are used for the same elements across various figures.

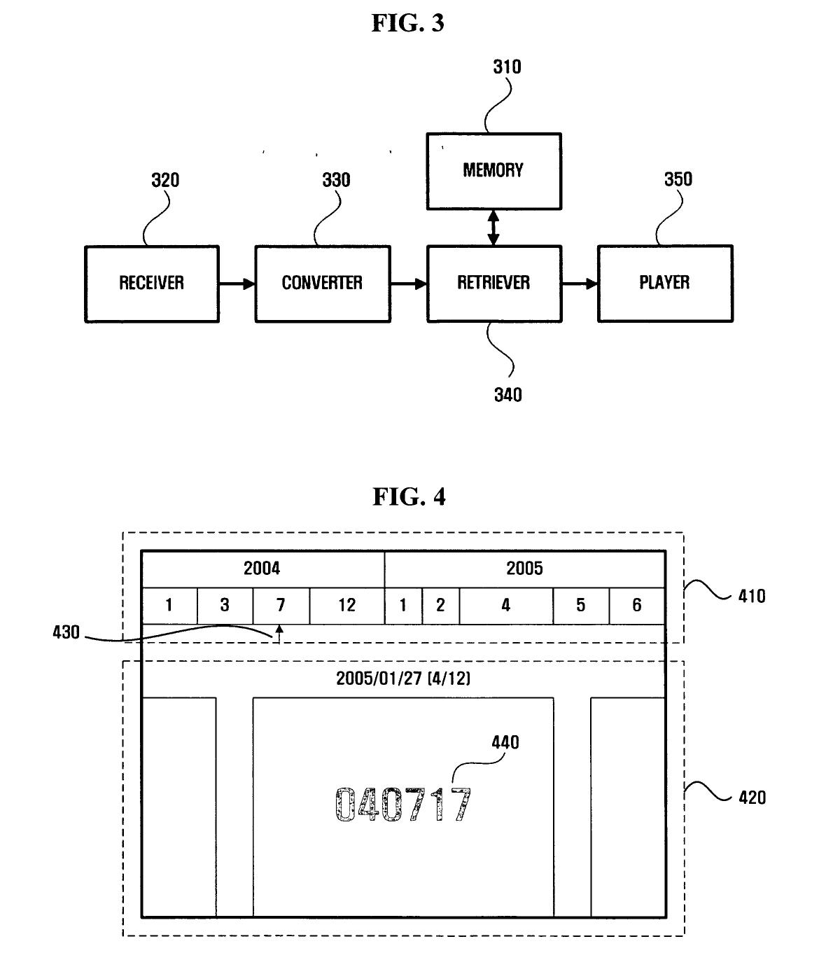

FIG. 3 is a block diagram illustrating the construction of an apparatus for playing content according to a numeral key input (hereinafter, referred to as a “playback apparatus”) according to an exemplary embodiment of the present invention. Referring to FIG. 3, the playback apparatus according to the exemplary embodiment of the present invention includes a memory 310, a receiver 320, a converter 330, a retriever 340, and a player 350.

The playback apparatus according to the exemplary embodiment of the present invention is an apparatus, such as a digital TV or a mobile phone, that cannot easily retrieve content stored therein. Although the playback apparatus according to the exemplary embodiment of the present invention cannot easily retrieve content using a mouse or an electronic pen in the manner that a desktop computer, a laptop computer, and a PDA can, content can be retrieved in the desktop computer, the laptop computer, and the PDA by a method which will be described later.

The memory 310 serves to store content. Examples of content include multimedia content and files. Examples of multimedia content include moving images and still images.

A general digital camera stores a still image photographed and stored in the Joint Photographic Experts Group (JPEG) format. A JPEG file includes an exchangeable image file (ExIF), which is additional information inserted into the JPEG file. The ExIF file includes photographing conditions, such as the camera model, shutter speed, exposure state, use of flash, and ISO setting value, and date and time of photograph.

Meanwhile, in the case where an image of the digital camera is not a still image or the still image is image-processed, the ExIF may not include the photograph date/time. In this case, although it is not possible to identify the photograph date and time, the date/time of the file generation can be identified. Therefore, in the present invention, in the case where the photograph date/time is not identified, the date/time of file generation is used.

Likewise, in the case where the still image photographed by the digital camera is not a JPEG file or the photograph date is not identified due to absence of the ExIF, the date/time of file generation may be used.

Examples of the memory 310 include a hard disk, a flash memory, a compact flash (CF) card, a secure digital (SD) card, a smart media (SM) card, a multimedia card (MMC), and a memory stick. The memory 310 is a module that can input and output information, and may be provided either inside the playback apparatus or in a separate apparatus. In the case where the memory 310 is provided in a separate apparatus, a predetermined communication means may be provided to communicate with the separate apparatus.

The receiver 320 serves to receive a combination of numerals input by a user. The playback apparatus of the present invention may be provided with a key input means or a communication means. The communication means receives a signal sent by a separate remote controller. The receiver 320 serves to receive a combination of numerals input by the key input means or the communication means. The combination of numerals corresponds to temporal information that includes at least one of year, month, day, hour, minute and second, and is a series of numerals input by the user. For example, the user may input arrow, dot, comma, and month after inputting year, to distinguish year from month.

The combination of numerals input by the user may depend on the type of multimedia content. That is, if multimedia content to be retrieved is a still image, the combination of numerals is regarded as retrieval of a photograph date, and thus, is converted into a date. If multimedia content to be retrieved is a moving image, the combination of numerals is regarded as retrieval of a specified position of the moving image, and thus. is converted into a time.

In other words, the user, who intends to input a date, can input a combination of four, six, or eight numerals. The combination of four numerals may be YYYY, YYMM, MMDD, and so on, where Y means year, M month, and D day. Therefore, YYYY means four-digit year, and YY, MM and DD respectively mean two-digit year, two-digit month and two-digit day. For example, using the key input means the user can press keys/buttons 2, 0, 0, and 5 to input 2005. Also, the user can press keys/buttons 0, 5, 0, and 6 corresponding to a combination of a two-digit year and a two-digit month so as to input the sixth month of 2005.

Likewise, the combination of six numerals may be YYYYMM and YYMMDD, and the combination of eight numerals may be YYYYMMDD.

Therefore, the user may input either a combination of numerals only or a combination of numerals and symbols. At this time, it is important to analyze the combinations of four numerals and six numerals. Combinations previously set by the user may be used as the combinations of four numerals and six numerals. In other words, if a combination of four numerals is input, it is analyzed as YYMM, and if a combination of six numerals is input, it is analyzed as YYMMDD.

The user, who intends to input a time, may input a combination of four numerals or a combination of six numerals. Examples of combinations of four numerals may include HHMM and MMSS, and an example of a combination of six numerals may include HHMMSS. In this case, H means hour, M means minute, and S means second. For example, in order to input a time, e.g., 1:30, the user can sequentially press keys/buttons 0, 1, 0, and 3 of the key input means. Also, in order to input the time, i.e., 2 hours, 33 minutes and 42 seconds, the user can press keys/buttons 0, 2, 3, 4, 4, and 2 of the key input means.

If the input time is four numerals, there may be confusion between HHMM and MMSS in the same manner as the date. This can be solved by a combination previously set by the user. The combination of input numerals is transferred to the converter 330. The converter 330 serves to convert the combination of input numerals into temporal information. The temporal information includes a date or time. The temporal information is regarded as a date if a still image or general file is retrieved, while it is regarded as time if a moving image is retrieved.

In other words, if content retrieved by the user is a still image or general file, the combination of the numerals input by the user is regarded as a date. If content retrieved by the user is a moving image, a combination of the numerals input by the user is regarded as a time. To this end, the converter 330 may recognize the type of content retrieved by the user. Thus, the converter 330 converts the transferred combination of numerals into temporal information using the analysis manner of the previously set combination of numerals and the type of the content to be retrieved.

For example, if the analysis manner of the previously set combination of numerals is YYMMDD or HHMMSS, the type of the content to be retrieved corresponds to a still image, and the transferred combination of numerals is: 030717, the converter 330 regards the transferred combination of numerals as a date and converts it into the temporal information “Jul. 17, 2003” by applying the format YYMMDD to 030717.

The converted temporal information is transferred to the retriever 340. The retriever 340 serves to retrieve stored content corresponding to the transferred temporal information with reference to the transferred temporal information. In other words, if the transferred temporal information corresponds to a date, the retriever 340 retrieves content such as a still image or file. If the transferred temporal information corresponds to time, the retriever 340 retrieves a specified position of a moving image.

For example, if the type of content is a still image and the transferred temporal information is: Jan. 27, 2005, the retriever 340 retrieves the still image photographed on Jan. 27, 2005. At this time, if there are plural still images photographed on Jan. 27, 2005, the retriever 340 can retrieve a first still image with reference to the photograph time. If plural files are arranged according to file name, file size, or others, the retriever 340 can retrieve them on that basis; e.g., the largest still image can be retrieved first.

Meanwhile, if there is no still image corresponding to the transferred date, a still image photographed after a corresponding date may be retrieved. If the time between the corresponding date and the date when the still image was photographed (after the corresponding date) exceeds a predetermined threshold value, a still image prior to the corresponding date may be retrieved.

For reference, if the retriever 340 retrieves still images, it retrieves files corresponding to the transferred date using the ExIF of the JPEG files stored in the memory 310. If the ExIF does not include the photograph date, or if the user intends to retrieve files such as documents, the retriever 340 can retrieve the corresponding content using the file generation date, not the photograph date. In other words, if the date is transferred as temporal information from the converter 330, the retriever 340 retrieves still images photographed on the transfer date. If there is no still image photographed on the corresponding date, the retriever 340 retrieves still images or files generated on the corresponding date.

The retrieved content is transferred to the player 350, and the player 350 plays the transferred content. As described above, the content includes files as well as multimedia content. If the retrieved content is a still image or a file, the player 350 displays the corresponding still image or file. Also, if the retrieved content is a moving image, the player 350 plays the moving image for the corresponding time.

Furthermore, the player 350 may display the combination of numerals input by the user. The combination of numerals input by the user may be displayed at the center of a screen to allow the user to easily recognize them. Alternatively, the combination of numerals input by the user may be displayed at the corner of the screen so as not to cover the content area.

At this time, if the content such as a still image or file is displayed, the relative quantity of the files photographed or generated on the corresponding date may be displayed by the position bar.

FIG. 4 is a view illustrating the displaying of still images according to an exemplary embodiment of the present invention.

The screen area where still images are displayed includes a still image area 420 and a position bar area 410. The still image area 420 displays the retrieved still images. Some of the still images existing before or after the retrieved still images may be displayed in the still image area 420. A corresponding date is displayed at the corner of the still image area 420. A numeral illustrating the order of the still images photographed on the corresponding date may be displayed at the corner of the still image area 420. For example, in the case of a fourth still image among twelve still images photographed on Jan. 27, 2005, a series of numerals such as 2005/01/27(4/12) are displayed as shown in FIG. 4.

Furthermore, a date 440 to be retrieved may be displayed in the still image area 420. The date 440 to be retrieved may be displayed either at the center of the still image area 420 to allow the user to easily recognize it, or at the corner of the still image area 420.

The position bar area 410 is to display the position according to a temporal axis of a displayed still image. Referring to FIG. 4, the position bar, divided into year and month, is displayed in the position bar area 410. Either a combination of year, month and day or a combination of month and day may be used as the position bar 410.

For example, referring to FIG. 4, illustrating months of specified years arranged in a matrix, the size of the matrix depends on the number of still images photographed or generated in a corresponding month. In other words, it can be seen through the position bar 410 of FIG. 4 that a relatively small number of still images were generated in January and February of 2005 while a relatively large number of still images were generated in April of 2005.

The position bar 410 may be used to allow the user to facilitate retrieval. That is, the user may use the relative size of the matrices of the position bar 410 to retrieve desired content among a mass of content.

Further, the position bar 410 may be used to inform the user of the relative position of content to be retrieved. In other words, if the user inputs a combination of numerals, the player 350 displays the combination of numerals 440 to display an approximate position of a corresponding date from the position bar 410. To this end, either an index icon 430 may be used, or the user may place the corresponding date at the center of the screen by moving the position bar 410 in left or right directions.

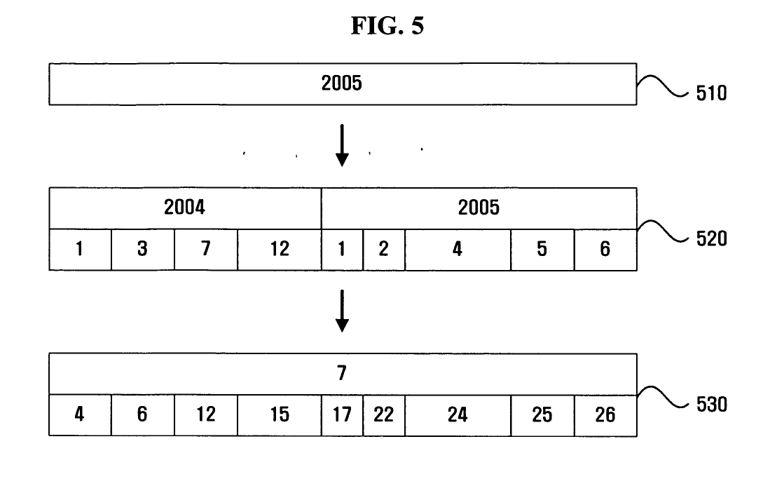

FIG. 5 is a view illustrating a display manner of the position bar according to an exemplary embodiment of the present invention.

If the still images are retrieved and displayed as shown in FIG. 4, the position bar 410 may be displayed. At this time, the position bar 410 may be displayed by a combination of year and month or a combination of month and day. This may depend on the combination of input numerals.

For example, if the user inputs 05 to display date of six numerals corresponding to Jan. 27, 2005, the year is displayed in a position bar 510 and the index icon is displayed in the position corresponding to 2005, or 2005 is displayed in the center of the screen. If the user inputs 01, corresponding to January, a matrix showing the month of each year is displayed in proportion to the content number, and the index icon is displayed in the position corresponding to January of 2005 or January of 2005 is displayed at the center of the screen. And, if the user inputs 27, corresponding to the 27th day, the year is deleted from a position bar 530, and a matrix showing each day of January is displayed in proportion to the content number, and the index icon is displayed in the position corresponding to the 27th day of January, or the 27th day of January is displayed in the center of the screen.

Therefore, the user can use an efficient retrieval process to approximately identify the amount of content generated on a certain day or in a certain month while inputting a combination of numerals.

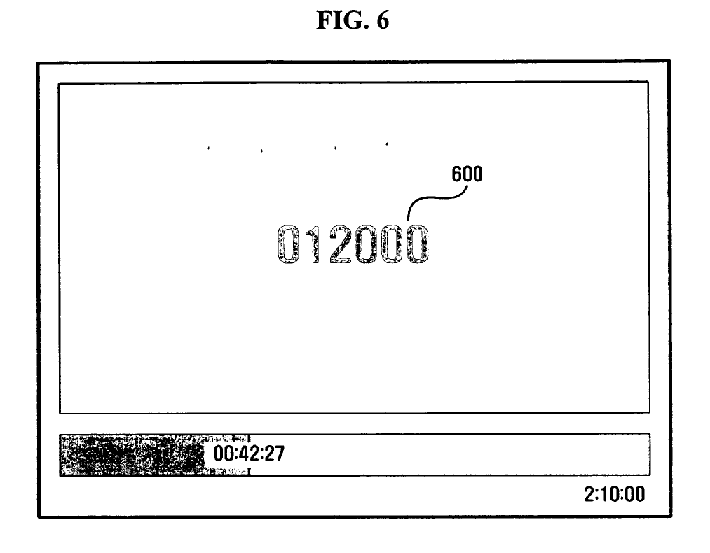

FIG. 6 is a view illustrates the displaying of moving images according to an exemplary embodiment of the present invention.

As described above, if the specified position of the moving image is to be retrieved, the retrieval time can be used. In other words, when a moving image is retrieved, the combination of input numerals is regarded as a time.

When a moving image is played, 15 to 30 frames are displayed per second. Therefore, the user can retrieve the moving image in the unit of seconds without difficulty. In this case, the user can input a combination 600 of four or six numerals.

If the specified position of the moving image is retrieved, the combination 600 of the input numerals is displayed in either the center of the screen or in the corner. The frame of the moving image is converted into the time corresponding to the combination 600 of the input numerals after a click of an end button or a lapse of a predetermined time.

For example, if the user inputs a combination of six numerals, i.e., 120000, which corresponds to 1 hour and 20 minutes, in the case of a two hour and ten minute moving image, the player 350 first plays the frames corresponding to the one hour and twenty minute point of time.

At this time, if the combination 600 of numerals that is input is not within the time range of the moving image, or is not suitable for display, the input data may be disregarded or an error message may be output. For example, if the user inputs 120000, which is 12 hours, 0 minutes and 0 seconds, in the case of a moving image of 2 hours and ten minutes, it is not within the time range of the moving image, and therefore, the retriever 340 stops retrieval, and waits for another retrieval command, or outputs an error message.

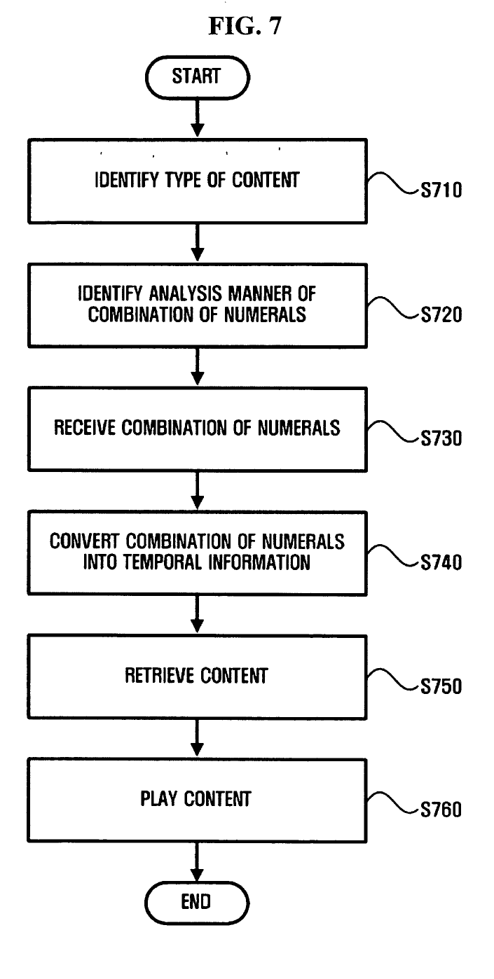

FIG. 7 is a flowchart illustrating a method for playing content according to a numeral key input according to an exemplary embodiment of the present invention.

To play content according to a numeral key input, the playback apparatus of the present invention identifies the type of content to be retrieved (S710). This operation S710 may be directly executed by the user. Alternatively, operation S710 may be executed by an application program that can play the content. In other words, the type of content is determined to be a still image or a file if the current application program is an output program for still images or files. On the other hand, the type of content is determined to be a moving image if the current application program is a playback program for a moving image.

Next, the analysis manner for the combination of numerals is identified (S720). The analysis manner includes a combination of four numerals, six numerals and eight numerals in the case of the date for retrieval of a still image or file, and a combination of four numerals or six numerals in the case of the date for retrieval of a moving image. The analysis manner depends on the user's setting. The combination of numerals may cause confusion, and may be analyzed depending on the previously set combination of numerals.

For reference, operation 720 may be executed prior to operation 710. Also, operations 710 and 720 may be executed after operation 730.

The receiver 320 receives a combination of numerals depending on user's input (S730). The user may input a combination of numerals using either the key input means provided in the playback apparatus or the remote controller. The receiver 320 receives a combination of numerals input by the key input means or the remote controller.

The combination of numerals is transferred to the converter 330. The converter 330 converts the transferred combination of numerals into temporal information (S740). At this time, the converter 330 refers to the previously identified type of content and the analysis manner of the combination of numerals. For example, if the received combination of numerals is 020323, the identified type of content corresponds to a still image and the combination of numerals has the format YYMMDD, and the received combination of numerals is converted into Mar. 23, 2002. And, if the received combination of numerals is 020323, the identified type of content corresponds to a moving image, and the combination of numerals has the format HHMMDD, the received combination of numerals is converted into two hours, three minutes and twenty-three seconds.

The converted temporal information is transferred to the retriever 340. The retriever 340 retrieves stored content corresponding to the temporal information among content stored in the memory 310 (S750). The retriever 340 retrieves content with reference to the identified type of content and the transferred temporal information. The identified type of content is used to determine a target for retrieval. In other words, if the type of content corresponds to a still image, a basic directory (folder) of the application program currently executing serves as a target for retrieving the content. If the type of content corresponds to a moving image, the moving image currently in execution serves as a target to be retrieved.

Therefore, if the identified type of content is a still image and the transferred combination of numerals is 050127, content having a photograph date or a generated date corresponding to Jan. 27, 2005 is retrieved from the basic directory (folder) of the application program currently executing. If the identified type of content is a moving image and the transferred combination of numerals is 012343, a position corresponding to 1 hour, 23 minutes and 43 seconds is retrieved from the moving image currently being played.

The retrieved content is played through the player 350 (S760). If the still image or file is retrieved, the player 350 displays the position bar while the user is inputting the combination of numerals. The location of the position bar may be varied depending on input operations of the combination of numerals. For example, when the analysis manner of the combination of numerals is six numerals and the combination of input numerals is 050127, if the user inputs 05, the position bar corresponding to a year is displayed. Subsequently, if the user inputs 01, the position bar corresponding to a month is displayed. Subsequently, if the user inputs 27, the position bar corresponding to a year is deleted while the position bar corresponding to a day is displayed.

The combination of numerals input by the user may be displayed at the center of the screen to allow the user to easily recognize it. Alternatively, the combination of numerals input by the user may be displayed at the corner of the screen so as not to cover the displayed content.

As described above, the apparatus and method for playing content according to a numeral key input has the following advantages.

First, a combination of numerals input using numeral keys is converted into temporal information such as a date or time, and stored frames of a still image or moving image corresponding to the temporal information are retrieved so that the user can conveniently retrieve a large amount of content.

In addition, the user can retrieve content in a desired manner through various kinds of combinations of numerals.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An apparatus for playing content, the apparatus comprising:
a receiver which receives a combination of numerals;
a converter which converts the received combination of numerals into temporal information;
a retriever which retrieves content corresponding to the temporal information with reference to the converted temporal information; and
a player which plays the retrieved content.

2. The apparatus as claimed in claim 1, wherein the combination of numerals corresponds to temporal information that includes at least one of a year, month, day, hour, minute, and second.

3. The apparatus as claimed in claim 1, wherein the converter converts the received combination of numerals into a date or a time depending on a type of the content to be retrieved.

4. The apparatus as claimed in claim 1, wherein the retriever retrieves content closest to the temporal information if there is no content corresponding to the temporal information.

5. The apparatus as claimed in claim 1, wherein the player displays a position of the temporal information corresponding to the retrieved content on a predetermined temporal axis using a position bar.

6. The apparatus as claimed in claim 1, wherein the combination of numerals is a combination of four, six or eight numerals input through a user interface.

7. A method for playing content, the method comprising:
receiving a combination of numerals;
converting the received combination of numerals into temporal information;
retrieving content corresponding to the temporal information with reference to the converted temporal information; and
playing the retrieved content.

8. The method as claimed in claim 7, wherein the combination of numerals corresponds to temporal information that includes at least one of a year, month, day, hour, minute, and second.

9. The method as claimed in claim 7, wherein the converting the received combination of numerals into the temporal information comprises converting the received combination of numerals into a date or a time depending on a type of content to be retrieved.

10. The method as claimed in claim 7, wherein the retrieving content comprises retrieving content closest to the temporal information if there is no content corresponding to the temporal information.

11. The method as claimed in claim 7, wherein the playing the retrieved content comprises displaying a position of the temporal information corresponding to the retrieved content on a predetermined temporal axis using a position bar.

12. The apparatus as claimed in claim 7, wherein the combination of numerals is a combination of four, six or eight numerals input through a user interface.
